(19) United States
(12) Patent Application Publication
(10) Pub. No.: US 2024/0229580 A1
(43) Pub. Date: Jul. 11, 2024

(54) DRILLING MACHINE WITH SMALL VOLUME AND HIGH SPEED FOR DUST-FREE MECHANICAL DRILLING

(71) Applicants: Jiangsu Zhongmei Mining Equipment Co., Ltd., Wuxi (CN); China University of Mining and Technology, Xuzhou (CN)

(72) Inventors: Jingyu JIANG, Xuzhou (CN); Gang CHEN, Wuxi (CN); Wentao HUANG, Wuxi (CN); Yi LIU, Wuxi (CN)

(21) Appl. No.: 18/611,649

(22) Filed: Mar. 20, 2024

Related U.S. Application Data
(63) Continuation of application No. PCT/CN2023/124897, filed on Oct. 17, 2023.

(30) Foreign Application Priority Data
Oct. 19, 2022 (CN) 202211276594.X

(51) Int. Cl. E21B 19/086; E21B 7/02; E21B 19/14; E21B 19/24; E21B 21/01

(52) U.S. Cl. CPC E21B 19/086; E21B 7/02; E21B 19/14; E21B 19/24; E21B 21/011

(57) ABSTRACT

A drilling machine including a main body, an operating mechanism; a harmonic speed changer, a centralizer; a drainage tube controlling assembly; a dust collection device, a caterpillar track unit, a drill rod storage frame, and an electric motor-oil pump conversion box. The caterpillar track unit is fixed on both sides of the main body, to move the main body; the operating mechanism and the electric motor-oil pump conversion box are disposed on the main body; the main body includes a main frame provided with a mounting plate; the mounting plate is connected to the operating mechanism through a rotary speed changer; the electric motor-oil pump conversion box is disposed on one side of the operating mechanism. The operating mechanism includes a sliding frame assembly, a sliding guide rod, a propulsion cylinder, a compensating cylinder, and a power head.

### CROSS-REFERENCE TO RELATED APPLICATIONS

This application is a continuation-in-part of International Patent Application No. PCT/CN2023/124897 with an international filing date of Oct. 17, 2023, designating the United States, now pending, and further claims foreign priority benefits to Chinese Patent Application No. 202211276594.X filed Oct. 19, 2022. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, MA 02142.

### BACKGROUND

The disclosure relates to the field of coal mine drilling, and more particularly to a drilling machine with small volume and high speed for dust-free mechanical drilling.

In mine tunneling operations, conventional roof bolters have a large size and width, and are inflexible and less adaptable in the narrow mine tunnel, it is difficult to alternate with the tunneling machine to operate. In the process of directional drilling, construction movement, and oscillation, the stability and flexibility of the roof bolters are greatly reduced, increasing the construction operating time.

In addition, the operation of high-speed drilling machines produces a large amount of dust rapidly, and most of the machines are ineffective to prevent the spread of dust, allowing such dust to float in the air, which not only poses a physical hazard to on-site construction personnel, but also block the operator's line of sight to the working environment, preventing real-time surveys to avoid critical situations, and causing great pollution to the environment.

### SUMMARY

The disclosure provides a drilling machine with small volume and high speed for dust-free mechanical drilling, the drilling machine comprising a main body, an operating mechanism; a harmonic speed changer, a centralizer; a drainage tube controlling assembly; a dust collection device, a caterpillar track unit, a drill rod storage frame, and an electric motor-oil pump conversion box.

The caterpillar track unit is fixed on both sides of the main body and in contact with a ground, to move the main body; the operating mechanism and the electric motor-oil pump conversion box are disposed on the main body; the main body comprises a main frame provided with a mounting plate; the mounting plate is connected to the operating mechanism through a rotary speed changer; the electric motor-oil pump conversion box is disposed on one side of the operating mechanism; the drill rod storage frame is connected to a front end of the mounting plate;
the operating mechanism comprises a sliding frame assembly, a sliding guide rod, a propulsion cylinder, a compensating cylinder, a compensating slide, and a power head; the propulsion cylinder and the compensating cylinder are disposed on the sliding frame assembly in parallel; the propulsion cylinder is connected to the sliding guide rod; the compensating cylinder is connected to the compensating slide; an outer wall of the propulsion cylinder is provided with a chain, and the chain is connected to the compensating cylinder; the power head is disposed on the sliding guide rod; the power head clamps a drill rod through a connector; the centralizer and the drainage tube controlling assembly are disposed on the sliding frame assembly; the centralizer, the drainage tube controlling assembly, and the power head are on a horizontal line;
the compensating slide is connected to a vertical rotary reducer; the vertical rotary reducer is connected to the harmonic speed changer; the harmonic speed changer comprises a support positioning column, a rack, and a harmonic reducer; the support positioning column is disposed on the mounting plate; the rack is disposed on an outer wall of the support positioning column; the harmonic reducer is connected to the rack; one side of the harmonic reducer is connected to the vertical rotary reducer through a support plate, and a horizontal rotary reducer is connected to a lower end of the harmonic reducer;
the centralizer comprises a base, a press plate, a sleeve, an insertion plate, a link rod, and a hydro-cylinder; two ends of the base are respectively equipped with shaft sleeves, and the shaft sleeves are fixed on the sliding frame assembly through connecting pieces; the press plate is disposed on the base; the sleeve is disposed on the press plate; the insertion plate is disposed in the sleeve in a plug-in way; the link rod is connected to a top end of the insertion plate via a first hinge pin; the link rod is connected to the hydro-cylinder; and hydro-cylinder is disposed on the press plate through a second hinge pin;
the drainage tube controlling assembly comprises a first shell, a second shell, a hydraulic motor, and a base plate; a first rear end of the first shell and a second rear end of the second shell are both hinged on the base plate; a first support tube is disposed on a first front end of the first shell and a second support tube is disposed on a second front end of the second shell; the first support tube and the second support tube are connected to the sliding frame assembly; a driving wheel and a driven wheel are disposed in the first shell; the driving wheel is engaged with the driven wheel through a transmission chain; the driving wheel is connected to the hydraulic motor; and two driven wheels are disposed in the second shell.

In a class of this embodiment, the insertion plate comprises a bottom end comprising a semicircular notch.

In a class of this embodiment, the first front end of the first shell is connected to the second front end of the second shell through a first tensioning spring; and the first rear end of the first shell is connected to the second rear end of the second shell through a second tensioning spring.

In a class of this embodiment, the drilling machine further comprises a dust collection device; the dust collection device comprises a collection bucket, a dust cage, a flexible conveyor, and a conveying motor; the dust cage comprises a horizontal pipe and a horn cover disposed below the horizontal pipe; one end of the horizontal pipe sleeves the drill rod, and the other end is connected to the collection bucket; and the horn cover of the dust cage is connected to the conveying motor through the flexible conveyor

In a class of this embodiment, each end of the horizontal pipe is provided with an annular brush.

In a class of this embodiment, the dust cage comprises a negative pressure drainage hole.

In a class of this embodiment, the drill rod storage frame comprises a plurality of connection plates; the plurality of connection plates are mutually connected to form a square frame with one side opening; each of two connection plates on two sides of the side opening is equipped with a pin, and the drill rod storage frame is fastened to the front end of the mounting plate through the pin to achieve a detachable assembly.

In a class of this embodiment, the power head has a drilling speed of approximately 750 r/min.

The following advantages are associated with the drilling machine of the disclosure.

1. The drilling machine of the disclosure is small, light, compact, and simple in operation and easy in maintenance; it can be adapted to the narrow construction space, so that the construction work can be completed quickly, and the operating efficiency of the drilling machine in the narrow space has been greatly improved.

2. The power head 24 adopts a high-speed power head, with a maximum drilling speed of 750 rpm and a maximum torque of 1300 N·M, which overcomes the problem of low hole formation rate and low efficiency during the drilling process in the soft and protruding coal seams; on the other hand, to solve the problem of instability brought by high rotational speed, the disclosure adopts harmonic reducer to drive the rack and pinion, to realize the up and down movement, which is more safe and reliable and the running is more stable, and solves the problem of shaking and instability brought by high rotational speed.

Moreover, the drill rod storage frame of the disclosure is equipped with a centralizer and a drainage tube controlling assembly, preventing the deviation, and the rotation of the drill rod is more stable and reliable; the sleeve below the drainage tube controlling assembly presses the driving wheel to tightly attach to the driven wheel, and the driving wheel drives the sleeve to move forward, thus achieving the pipe feeding operation; after disengaging from the drainage tube controlling assembly, the sleeve is automatically reset due to weightlessness, to further stabilize the drill rod.

3. The dust collection device of the disclosure is conducive to the dust-free operation, the collection bucket and the dust cage cooperate to collect dust, thus minimizing the hazards of dust to human body.

### BRIEF DESCRIPTION OF THE DRAWINGS

FIG. 1 is a schematic diagram of a drilling machine with small volume and high speed for dust-free mechanical drilling of the disclosure;

FIG. 2 is a front view of a drilling machine with small volume and high speed for dust-free mechanical drilling of the disclosure;

FIG. 3 is a top view of a drilling machine with small volume and high speed for dust-free mechanical drilling of the disclosure;

FIG. 4 is a front view of a dust collection device of the disclosure;

FIG. 5 is a schematic diagram of a harmonic speed changer of the disclosure;

FIG. 6 is a top view of a harmonic speed changer of the disclosure;

FIG. 7 is a schematic diagram of a drill rod storage frame of the disclosure;

FIG. 8 is a schematic diagram of a centralizer of the disclosure;

FIG. 9 is a side view of a centralizer of the disclosure;

FIG. 10 is a schematic diagram of a drainage tube controlling assembly of the disclosure;

FIG. 11 is a front view of a drainage tube controlling assembly of the disclosure; and

FIG. 12 is a sectional view of a drainage tube controlling assembly of the disclosure.

In the drawings, the following reference numbers are used: 1. Main body; 11. Mounting plate; 2. Operating mechanism; 21. Sliding frame assembly; 22. Sliding guide rod; 23. Propulsion cylinder; 24. Power head; 25. Compensating cylinder; 26. Compensating slide; 3. Harmonic speed changer; 31. Support positioning column; 32. Rack; 33. Harmonic reducer; 4. Centralizer; 41. Base; 42. Press plate; 43. Sleeve; 44. Insertion plate; 45. Link rod; 46. Hydro-cylinder; 5. Drainage tube controlling assembly; 51. First shell; 52. Second shell; 53. Driving wheel; 54. Transmission chain; 55. Hydraulic motor; 56. Driven wheel; 57. Tensioning spring; 58. Support tube; 59. Base plate; 6. Dust collection device; 61. Collection bucket; 62. Dust cage; 63. Annular brush; 64. Flexible conveyor; 65. Conveying motor; 71. Horizontal rotary reducer; 72. Vertical rotary reducer; 8. Caterpillar track unit; 9. Drill rod storage frame; 91. Connection plate; 92. Pin; 10. Electric motor-oil pump conversion box; 101. Inspection window.

### DETAILED DESCRIPTION

To further illustrate the disclosure, embodiments detailing a drilling machine with small volume and high speed for dust-free mechanical drilling are described below. It should be noted that the following embodiments are intended to describe and not to limit the disclosure.

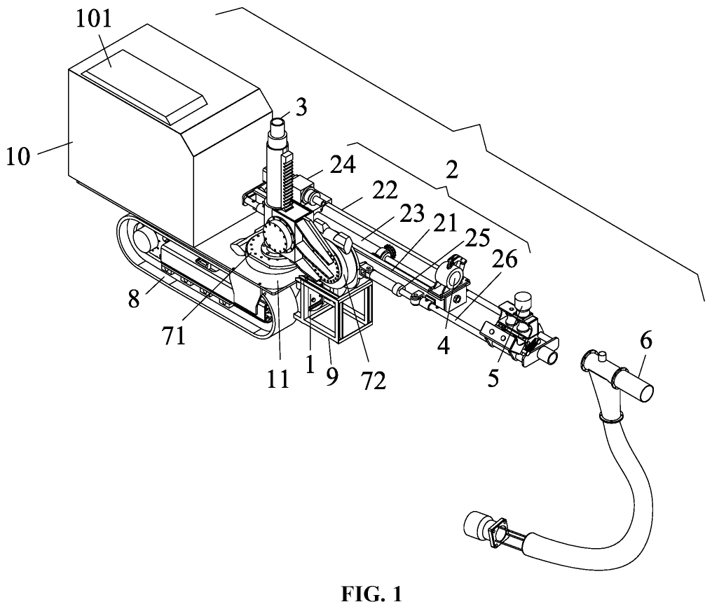

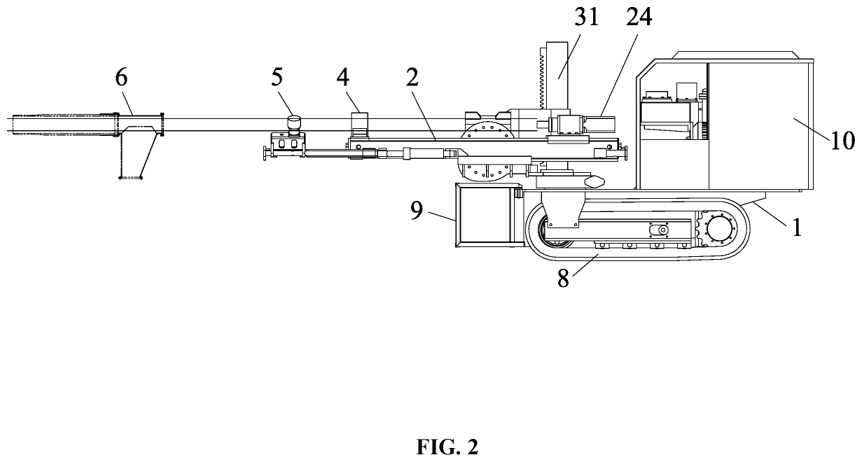

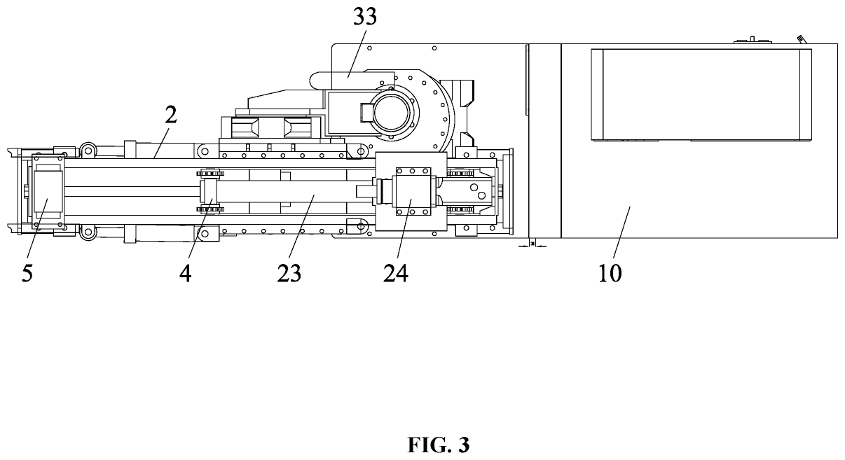

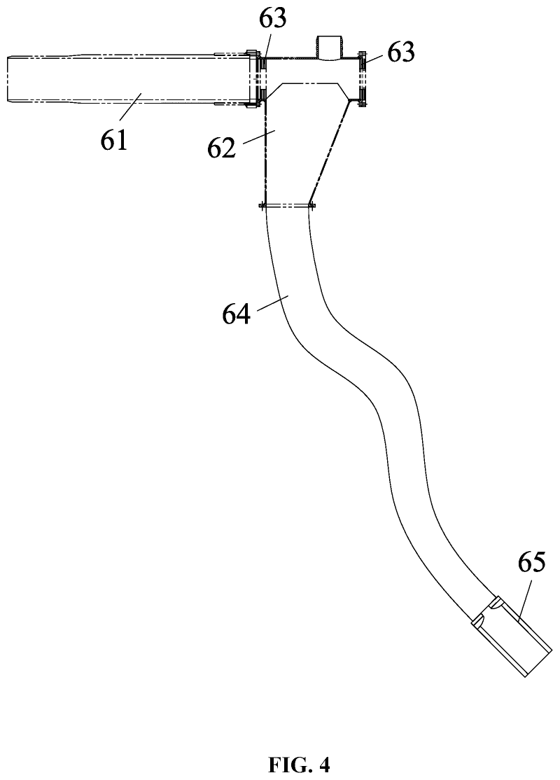

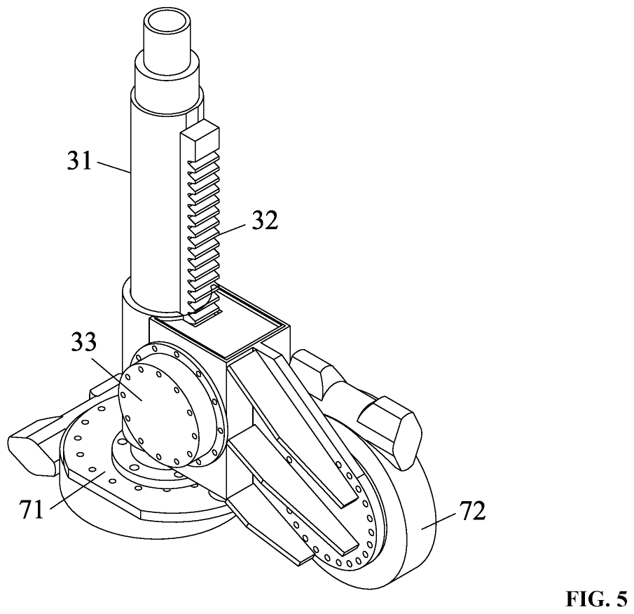

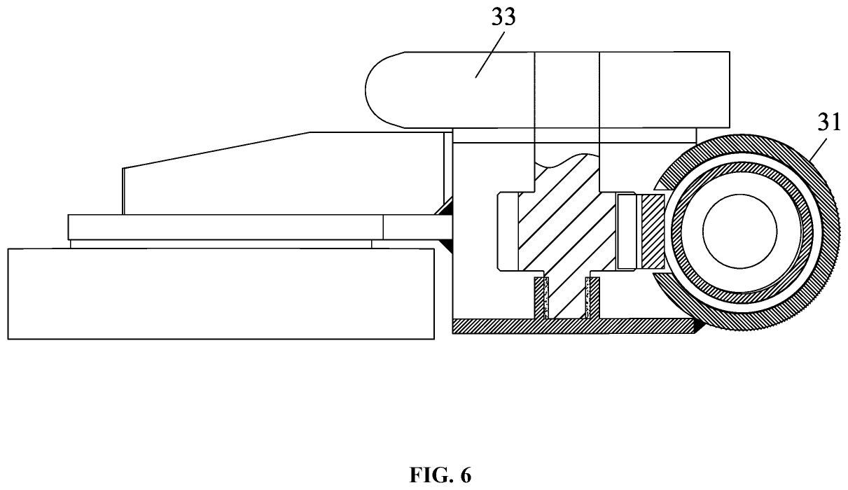

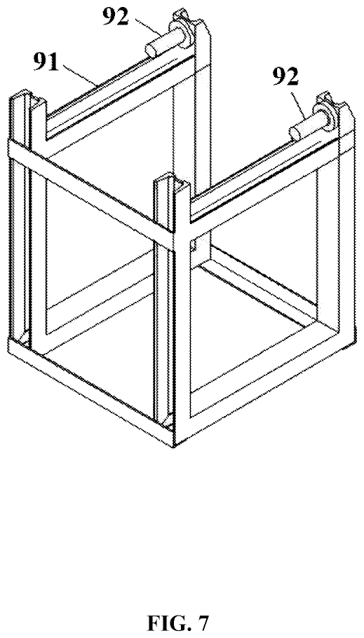

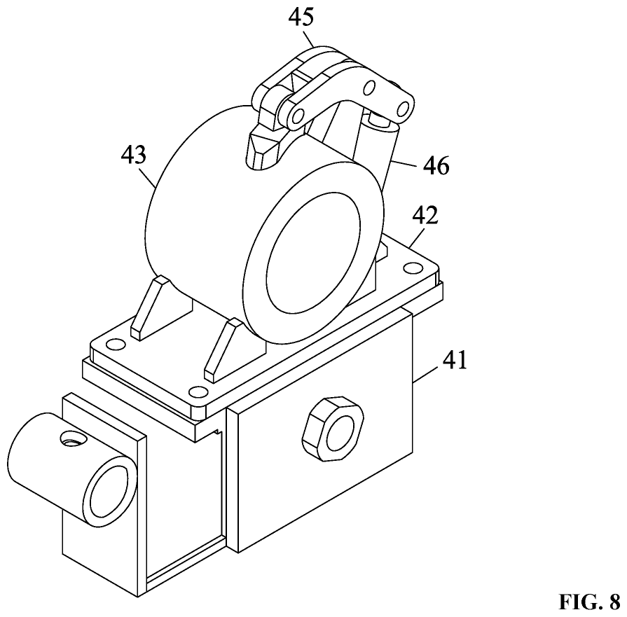

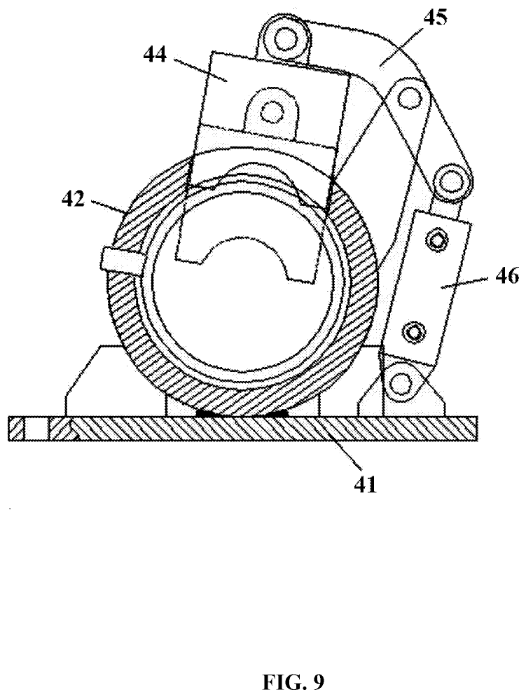

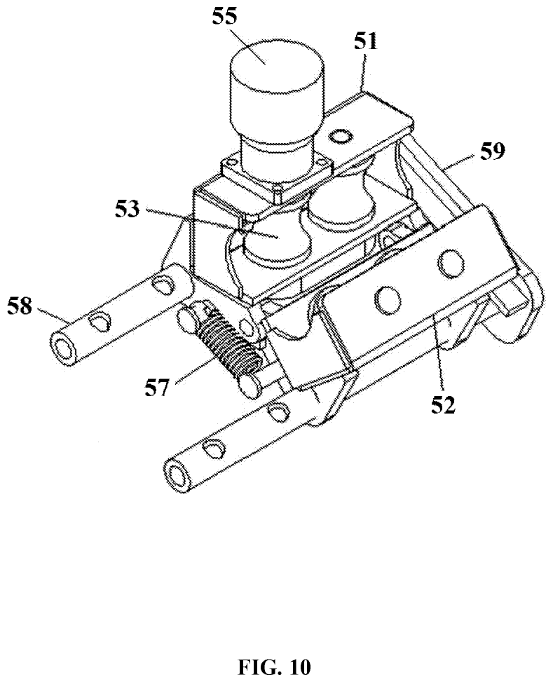

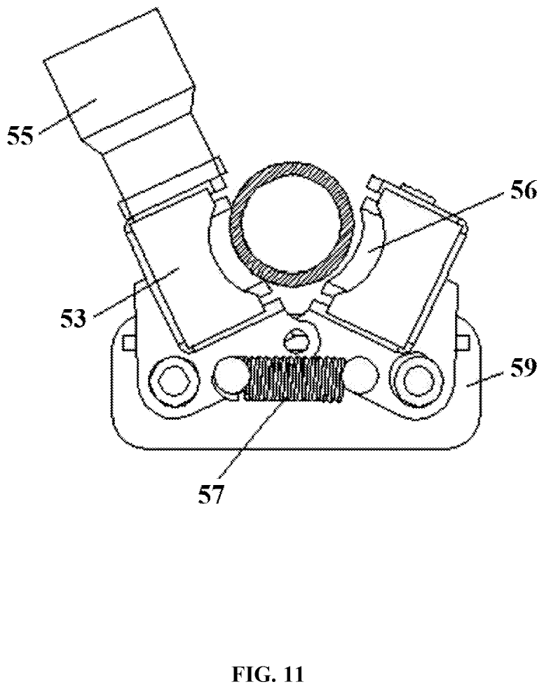

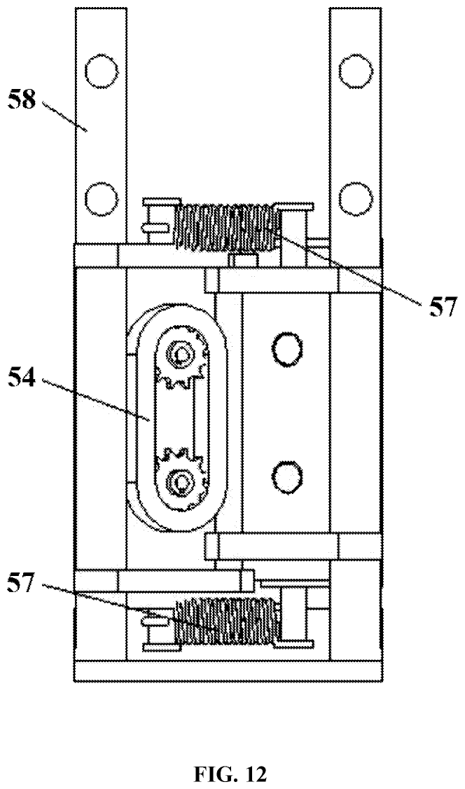

As shown in FIGS. 1-12, FIG. 1 is a schematic diagram of a drilling machine with small volume and high speed for dust-free mechanical drilling of the disclosure. The drilling machine comprises a main body 1, an operating mechanism 2, a harmonic speed changer 3, a centralizer 4, a drainage tube controlling assembly 5, a dust collection device 6, a caterpillar track unit 8, a drill rod storage frame 9, and an electric motor-oil pump conversion box 10. The caterpillar track unit 8 is fixed on both sides of the main body 1 and in contact with a ground, to move the main body; the operating mechanism 2 and the electric motor-oil pump conversion box 10 are disposed on the main body 1.

The main body 1 comprises a main frame provided with a mounting plate 11; the mounting plate 11 is connected to the operating mechanism 2 through a rotary speed changer; the electric motor-oil pump conversion box 10 is disposed on one side of the operating mechanism 2; the drill rod storage frame 9 is connected to a front end of the mounting plate 11.

The operating mechanism 2 comprises a sliding frame assembly 21, a sliding guide rod 22, a propulsion cylinder 23, a compensating cylinder 25, a power head 24, and a compensating slide 26; the propulsion cylinder 23 and the compensating cylinder 25 are disposed on the sliding frame assembly 21 in parallel; the propulsion cylinder 23 is connected to the sliding guide rod 22; the compensating cylinder 25 is connected to the compensating slide 26; an outer wall of the propulsion cylinder 23 is provided with a chain, and the chain is connected to the compensating cylinder; the power head 24 is disposed on the sliding guide rod 22; the power head 24 clamps a drill rod through a connector; the centralizer 4 and the drainage tube controlling assembly 5 are disposed on the sliding frame assembly 21; the centralizer 4, the drainage tube controlling assembly 5, and the power head 24 are on a horizontal line.

The power head 24 adopts a high-speed power head, with a maximum drilling speed of 750 rpm and a maximum torque of 1300 N·M.

The compensating slide 26 is connected to a vertical rotary reducer 72; the vertical rotary reducer 72 is connected to the harmonic speed changer 3.

The stroke doubling mechanism of the propulsion cylinder 23 and the chain enables the power component to quickly move forward and backward, in order to load and unload the drill rod and achieve drilling and retraction of the drill rod. The compensating cylinder plays a compensation role when drilling holes in the same horizontal or vertical position.

The harmonic speed changer 3 comprises a support positioning column 31, a rack 32, and a harmonic reducer 33; the support positioning column 31 is disposed on the mounting plate 11; the rack 32 is disposed on an outer wall of the support positioning column 31; the harmonic reducer 33 is connected to the rack 32; one side of the harmonic reducer 33 is connected to the vertical rotary reducer 72 through a support plate, and a horizontal rotary reducer 71 is connected to a lower end of the harmonic reducer 33.

The centralizer 4 comprises a base 41, a press plate 42, a sleeve 43, an insertion plate 44, a link rod 45, and a hydro-cylinder 46; two ends of the base 41 are respectively equipped with shaft sleeves, and the shaft sleeves are fixed on the sliding frame assembly 21 through connecting pieces; the press plate 42 is disposed on the base 41; the sleeve 43 is disposed on the press plate 42; the sleeve 43 is cylindrical in shape and is fixed by a hexagon socket set screws with flat point; the insertion plate 44 is disposed in the sleeve 43 in a plug-in way; the insertion plate 44 comprises a bottom end comprising a semicircular notch; the link rod 45 is connected to the top end of the insertion plate 44 via a first hinge pin; the link rod 45 is connected to the hydro-cylinder 46; and hydro-cylinder 46 is disposed on the press plate 42 through a second hinge pin.

The drainage tube controlling assembly 5 comprises a first shell 51, a second shell 52, a hydraulic motor 55, and a base plate 59; a first rear end of the first shell 51 and a second rear end of the second shell 52 are both hinged on the base plate 59; a first support tube 58 is disposed on a first front end of the first shell 51 and a second support tube 58 is disposed on a second front end of the second shell 52; the first support tube 58 and the second support tube 58 are connected to the sliding frame assembly 21; a driving wheel 53 and a driven wheel 56 are disposed in the first shell 51; the driving wheel 53 is engaged with the output shaft of the driven wheel 56 through a transmission chain 54; the driving wheel 53 is connected to the hydraulic motor 55; the hydraulic motor 55 drives the driving wheel 53, thereby driving the driven wheel 56 in a transmission way; two driven wheels are disposed in the second shell 52 for rolling transmission; when the drill rod passes through, the driving wheel 53 on one side drives the sleeve forward, and the driven wheel on the other side is driven to roll by the transmission force, thus reducing the friction.

The first front end of the first shell 51 is connected to the second front end of the second shell 52 through a first tensioning spring 57; and the first rear end of the first shell 51 is connected to the second rear end of the second shell 52 through a second tensioning spring 57, so as to adjust the opening angle of the drainage tube controlling assembly to adapt to different sizes of drilling rods.

The drilling machine further comprises a dust collection device 6; the dust collection device 6 comprises a collection bucket 61, a dust cage 62, a flexible conveyor 64, and a conveying motor 65; the dust cage 62 comprises a horizontal pipe and a horn cover disposed below the horizontal pipe; one end of the horizontal pipe sleeves the drill rod, and the other end is connected to the collection bucket 61; and the horn cover of the dust cage 62 is connected to the conveying motor 65 through the flexible conveyor 64.

Each end of the horizontal pipe is provided with an annular brush 63.

The dust cage 62 comprises a negative pressure drainage hole.

The caterpillar track unit 8 comprises a first walking part and a second walking part symmetrically arranged on both sides of the mounting plate 11. The first side of the mounting plate 11 is connected to the first walking part through a first connecting frame, and the second side is connected to the second walking part through a second connecting frame.

The first walking part comprises a sealed track assembly, a guide wheel, a sprocket, a track frame, a tension buffer device, and five supporting wheels. The sealed track assembly comprises a sealed track chain made of high-strength alloy steel. The track chain is disposed on the sprocket and the guide wheel. The guide wheel is connected to the track frame. The tension buffer device is disposed on the track frame, and five supporting wheels are connected to the lower end of the track frame. The sprocket is connected to a walking motor, which drives the sprocket to achieve the walking of the track chain.

The drill rod storage frame 9 comprises a plurality of connection plates 91; the plurality of connection plates are mutually connected to form a square frame with one side opening; each of two connection plates 91 on two sides of the side opening is equipped with a pin 92, and the drill rod storage frame 9 is fastened to the front end of the mounting plate 11 through the pin 92 to achieve a detachable assembly.

The top end of the electric motor-oil pump conversion box 10 comprises an inspection window 101.

Working principle:
the horizontal rotary reducer is disposed on the lower part of the harmonic reducer, to achieve the horizontal rotation, which is suitable for multi-directional exploration and drilling operations, and in combination with the vertical rotary reducer, to achieve drilling in all directions.

The hydraulic oil cylinder is lifted and lowered by using the harmonic reducer to drive the gears and racks, achieving vertical up and down movement. The conventional hydraulic self-locking is replaced by a mechanical self-locking of the harmonic reducer, which is safer and more reliable. The hydraulic oil cylinder can be fixed even if the hydraulic oil leaks. Due to the compressibility of the hydraulic oil, there is a certain degree of vibration in the hydraulic cylinder, while the up and down movement of the gear and rack is smooth. The lifting and lowering of the oil cylinder is limited by the stroke range, while the gear range of the harmonic reducer can be increased or decreased arbitrarily, without limiting the stroke.

When drilling, the water-vapor combined drilling is used, thus reducing the dust; the collection bucket is inserted into the coal wall to collect coal dust; the built-in annular brush cleans the coal dust and has the effect of dust reduction, and the collected coal dust is transported to a designated location for centralized treatment through the flexible conveyor, thus reducing the wind dust in the coal mine.

It will be obvious to those skilled in the art that changes and modifications may be made, and therefore, the aim in the appended claims is to cover all such changes and modifications.

What is claimed is:

1. A drilling machine, comprising:
a main body;
an operating mechanism;
a harmonic speed changer;
a centralizer;
a drainage tube controlling assembly;
a dust collection device;
a caterpillar track unit;
a drill rod storage frame; and
an electric motor-oil pump conversion box;
wherein:
the caterpillar track unit is fixed on both sides of the main body and in contact with a ground, to move the main body; the operating mechanism and the electric motor-oil pump conversion box are disposed on the main body; the main body comprises a main frame provided with a mounting plate; the mounting plate is connected to the operating mechanism through a rotary speed changer; the electric motor-oil pump conversion box is disposed on one side of the operating mechanism; the drill rod storage frame is connected to a front end of the mounting plate;
the operating mechanism comprises a sliding frame assembly, a sliding guide rod, a propulsion cylinder, a compensating cylinder, a compensating slide, and a power head; the propulsion cylinder and the compensating cylinder are disposed on the sliding frame assembly in parallel; the propulsion cylinder is connected to the sliding guide rod; the compensating cylinder is connected to the compensating slide; an outer wall of the propulsion cylinder is provided with a chain, and the chain is connected to the compensating cylinder; the power head is disposed on the sliding guide rod; the power head clamps a drill rod through a connector; the centralizer and the drainage tube controlling assembly are disposed on the sliding frame assembly; the centralizer, the drainage tube controlling assembly, and the power head are on a horizontal line;
the compensating slide is connected to a vertical rotary reducer; the vertical rotary reducer is connected to the harmonic speed changer; the harmonic speed changer comprises a support positioning column, a rack, and a harmonic reducer; the support positioning column is disposed on the mounting plate; the rack is disposed on an outer wall of the support positioning column; the harmonic reducer is connected to the rack; one side of the harmonic reducer is connected to the vertical rotary reducer through a support plate, and a horizontal rotary reducer is connected to a lower end of the harmonic reducer;
the centralizer comprises a base, a press plate, a sleeve, an insertion plate, a link rod, and a hydro-cylinder; two ends of the base are respectively equipped with shaft sleeves, and the shaft sleeves are fixed on the sliding frame assembly through connecting pieces; the press plate is disposed on the base; the sleeve is disposed on the press plate; the insertion plate is disposed in the sleeve in a plug-in way; the link rod is connected to a top end of the insertion plate via a first hinge pin; the link rod is connected to the hydro-cylinder; and hydro-cylinder is disposed on the press plate through a second hinge pin; and
the drainage tube controlling assembly comprises a first shell, a second shell, a hydraulic motor, and a base plate; a first rear end of the first shell and a second rear end of the second shell are both hinged on the base plate; a first support tube is disposed on a first front end of the first shell and a second support tube is disposed on a second front end of the second shell; the first support tube and the second support tube are connected to the sliding frame assembly; a driving wheel and a driven wheel are disposed in the first shell; the driving wheel is engaged with the driven wheel through a transmission chain; the driving wheel is connected to the hydraulic motor; and two driven wheels are disposed in the second shell.

2. The drilling machine of claim 1, wherein the insertion plate comprises a bottom end comprising a semicircular notch.

3. The drilling machine of claim 1, wherein the first front end of the first shell is connected to the second front end of the second shell through a first tensioning spring; and the first rear end of the first shell is connected to the second rear end of the second shell through a second tensioning spring.

4. The drilling machine of claim 1, further comprising a dust collection device; wherein the dust collection device comprises a collection bucket, a dust cage, a flexible conveyor, and a conveying motor; the dust cage comprises a horizontal pipe and a horn cover disposed below the horizontal pipe; one end of the horizontal pipe sleeves the drill rod, and the other end is connected to the collection bucket; and the horn cover of the dust cage is connected to the conveying motor through the flexible conveyor.

5. The drilling machine of claim 4, wherein each end of the horizontal pipe is provided with an annular brush.

6. The drilling machine of claim 4, wherein the dust cage comprises a negative pressure drainage hole.

7. The drilling machine of claim 1, wherein the drill rod storage frame comprises a plurality of connection plates; the plurality of connection plates are mutually connected to form a square frame with one side opening; each of two connection plates on two sides of the side opening is equipped with a pin, and the drill rod storage frame is fastened to the front end of the mounting plate through the pin to achieve a detachable assembly.

8. The drilling machine of claim 1, wherein the power head has a drilling speed of approximately 750 r/min.
